(19) United States
(12) Patent Application Publication
(10) Pub. No.: US 2019/0370718 A1
(43) Pub. Date: Dec. 5, 2019

(54) POSITIVE DIVERGENCE ANALYSIS

(71) Applicant: Jack Wayne Morehouse, (US)

(72) Inventor: Jack Wayne Morehouse, (US)

(21) Appl. No.: 16/327,324

(22) PCT Filed: May 8, 2018
(86) PCT No.: PCT/US18/31676

§ 371 Date: Jul. 1, 2019

Related U.S. Application Data
(60) Provisional application No. 62/468,880, filed on Mar. 8, 2017.

(51) Int. Cl. G06Q 10/06; G06F 17/27

(52) U.S. Cl. CPC G06Q 10/06393; G06F 17/2705; G06F 17/2775

(57) ABSTRACT

The present invention deals with Positive Divergence Analysis which enables the determination of various factors which can be used by an organization to improve employee engagement based upon analysis of responses by the employees to a plurality of survey questions.

### CROSS-REFERENCE TO RELATED APPLICATIONS

This applications claims the benefit of U.S. provisional utility patent application No. 62/468,880 filed on 8 Mar. 2017

### BACKGROUND OF THE INVENTION

Businesses have been conducting surveys of their employees for decades. Many businesses conduct such surveys in order to gather information referred to as “Employee Satisfaction”, “Employee Attitudes”, “Employee Commitment” and “Employee Engagement.”

It has been estimated that anywhere from 50% to 75% of businesses and organizations conduct such surveys. It is generally understood that businesses that conduct such surveys have a competitive advantage because they provide significant and powerful insight into the attitudes of their employees and a means to measure or evaluate the effect of various policies and programs that have been implemented in order to increase productivity, motivation, and overall organizational productivity. Surveys can provide several key benefits. Surveys and the analysis of their results:
a. Generate answers to questions such as what motivates employees, what deficits the employees see in how the company operates, what are the most important areas that the employees believe the company needs to correct, among others.
b. Provide a basis for discussions between the employees and management regarding the areas that need improvement or change.
c. Provide objective information which can form the basis for changes in various company operational parameters.
d. Provide a means evaluate whether changes made in response to surveys are in fact improving employee engagement, how employees feel about the company, their commitment to the company, and increases in sales, profits, and customer retention.

Studies have shown that about 70% of human resource professionals think that employee engagement is the best indicator of the effectiveness of various management practices. Employee engagement is now the current focus of employee surveys. There are various definitions of what engagement actually is and how to measure it. One definition of engagement is described in an article by Macey and Schneider (“The Meaning of Employee Engagement.” Industrial and Organizational Psychology, 1, 3-30)

Macey and Schneider consider engagement to consist of three elements. These are: a. Trait Engagement, b. State Engagement and c. Behavioral Engagement. Trait Engagement measures inherent personality aspects that help facilitate the employee's engagement. State Engagement is a psychological and/or emotional state of the employee that is the precursor to action on the part of the employee. This aspect of engagement responds well to various improvements by management and leadership. Behavioral Engagement is actual discretionary effort by the employee which results in increased productivity and higher performance.

Employee engagement has been shown to be a good predictor of market value. Companies having high level of employee engagement (75% percentile) tended to perform better than the market index and an increase in shareholder return that was 50% greater than the average in 2011. For those companies with a low employee engagement (in bottom quartile) had a shareholder return that was 50% lower than the average. (Aon Hewitt, 2013 Trends in Global Employee Engagement)

Though surveys have traditionally been paper-based, with the advancement in technology and access to high-speed Internet services, more and more companies are using technology based administration of surveys. These are usually divided into programs running on local computers or on web-based administration, which makes the storage and analysis of large number of employees centralized and more efficient.

At the close of an employee survey, the analytics used to evaluate employee responses have gotten increasingly more sophisticated and complicated. Such techniques as Relative Weight Analysis, Structural Equation Modeling or Correlation and Regression are becoming required skills for a Human Resource department in order to provide analysis of the survey data. This analysis usually requires employees having advance degrees in industrial psychology, engineering, economics and statistics. These analytical techniques are used to establish a link between the survey data and objective business metrics such as employee retention, customer satisfaction and sale growth. Without the proper understanding of these advanced analytics, management cannot effectively action plan or administer any feedback or next steps as a result of the survey. As a result, the organization is not fully utilizing and benefiting from the data collected from their employee survey.

In addition, any time a new question or survey item is analyzed, the analytical programming to update this change for the huge amount of data can take significant time and resources to reprogram. Again, this is not something that an organization can undertake unless they have a highly trained and sophisticated Human Resources and IT department and it certainly isn't accessible at the manager level.

What is needed is a method of analyzing and identifying areas that need improvement in an organization that is accurate, intuitive, and actionable. This method would need to be simple enough that non-mathematicians, non-statisticians, and management at any level could perform the type of analysis they need without having a degree in statistics.

### SUMMARY OF THE INVENTION

The term Divergence Analysis and positive Divergence Analysis has been used frequently in the field of stock market analysis and vector calculus. It should be understood that the invention described herein and titled Positive Divergence Analysis has no relation to the stock market, vector analysis or any of the mathematical algorithms used in those fields.

The present invention is a method for enhancing or improving a financial/business metric for an organization. The method comprises the following steps.
a. generate a survey comprising a plurality of survey questions, the answers to which will provide useful information for the organization;
b. administer the survey to a plurality of employees of the organization;
c. identify a first subset of said survey questions such that a first subset of said employees answered said first subset of survey questions with positive or favorable responses;
d. identify a second subset of employees who each answered the first subset of survey questions with negative or unfavorable responses;
e. identify a second subset of survey questions in which the first subset of employees answered each question with positive responses and which each question in the second subset of survey questions were answered by each employee in the second subset of employees with less positive or less favorable responses.

Then the questions in the second subset are sorted into those questions that have the largest difference between the favorable responses from the first subset of respondents and the favorable responses from the second subset of respondents. This ranking permits the organization to identify the subject matter of the survey questions that have the largest difference (Positive Divergence) of favorable responses between the first subset and the second subset of employees and thus the organization can make changes to its policies and procedures to enhance the favorable response level for the employees or respondents in the second subset.

### DESCRIPTION OF THE INVENTION

The present invention is a method of identifying the operational changes needed within an organization that will have the highest level of impact in order to enhance desirable organizational metrics such as profitability, employee engagement, retention, efficiency, and product quality, to name but a few. The method requires administering questionnaires or surveys to the employees that are designed to gather information about the employees' feelings and opinions about a wide range of the organization's activities, policies and procedures. The questions are formulated to gather information about a number of broad categories that are important in the understanding of organizational health. Such categories include but are not limited to: Clarity of Direction, Effective Management, Collaboration & Teamwork, Employee Enablement & Empowerment, Commitment to Quality & Innovation, Recognition & Reward, and Pride in the Company. The subject matter of all of these categories and similar categories shall be referred to herein as “engagement.” The specific categories used will be dependent on the nature of the organization's business.

As used herein the term “organization” is meant to include businesses, clubs, churches, Meet-up groups, corporations, non-profit corporations and fraternal organizations including but not limited to The Elks, Rotary Club, and VFW. The term “employee” is meant to include all persons who are employees of an organization, a member of an organization and any person who belongs to or participates in the activities of an organization.

Responses to the questionnaires or surveys will generally include a range of possible responses. One range of responses can be based upon the level of agreement such as Strongly Agree, Agree, Neutral, Disagree, and Strongly Disagree; to positive, declarative statements. This range of possible responses will be used throughout this specification, but it should be understood that any number of other ranges or scales could be used. Such ranges might be scales like agreement, frequency, satisfaction, and any number of options (e.g. 1 to 5, 1 to 6, 1 to 7 or 1 to 10, etc.). As used herein, the responses Strongly Agree and Agree may be referred to as Favorable and responses that include Neutral, Disagree and Strongly Disagree may be referred to as Unfavorable. Any means of ranking responses from the employees can be grouped together into either a Favorable or Unfavorable designation.

A very simplified example of how the invention is implemented is now described. First, the responses to a particular question (e.g. Question 1) are reviewed and those employees who answered favorably (i.e. either Strongly Agree or Agree) will be identified as Group One, which identifies Group one as being engaged. Those employees who did not answer Question 1 favorably (i.e. Neutral, Disagree or Strongly Disagree) to the same question will be identified as Group Two and are considered less engaged.

Then a comparison is made of the responses of these two groups to each of the other questions in the survey. For example, assume that Group One had a 75% favorable response to Question 2 and Group Two had a 50% favorable response to Question 2. Thus there is a 25% Positive Divergence for Question 2 between Group One and Group Two. That is, Group One had an increase in 25 points (Positive Divergence) over Mat of Group Two to Question 2. That is, Group One had a 25-point higher favorable response to Question 2. than Group 2.

This same analysis is done for all of the other questions in the survey. In this example, assume there are 5 questions in the survey or four questions in addition to the first question (used to identify Group One from Group 2) and the Positive Divergence Analysis for Questions 2-5 results in the following:

| | Group 1 | Group 2 | Divergence |
|---|---|---|---|
| Question 2 | 75% favorable | 50% favorable | 25% Positive |
| | | | Divergence |
| Question 3 | 89% favorable | 75% favorable | 14% Positive |
| | | | Divergence |
| Question 4 | 60% favorable | 10% favorable | 50% Positive |
| | | | Divergence |
| Question 5 | 85% favorable | 25% favorable | 60% Positive |
| | | | Divergence |

The largest Positive Divergence is seen in Question 5 with a 60 point Positive Divergence. In other words, what are the people in Group One experiencing as positive that the people in Group 2 did not experience as positive? By ordering the survey items with the largest difference in Positive Divergence we can find the largest Positive Divergence of experience between the two groups. If the subject matter in Question 5 (the largest Positive Divergence) is addressed by the organization's management in an effort to increase the ratings by the employees in Group 2, the time and effort will be more likely to yield increased ratings for the subject matter of Question 5, but also more likely to provide the highest improvement of the ratings by the employees in Group 2 for the subject matter of Question 5.

By addressing the subject matter of Question 5, not only are the responses to Question 5 addressed, but more importantly the responses to Question 1 are most likely to improve. Question 1 (or groupings of several questions) can deal with the any subject matter of interest and by addressing the subject matter of Question 5, the responses of the employees in the second subset to Question 1 can be improved.

If Positive Divergence Analysis is done for all the questions in the survey, then it is possible to rank the questions having the largest Positive Divergence. By identifying the subject matter of the questions having the largest Positive Divergence, the organization's management will have guidance as to what types of changes in the organization's overall management will yield the most benefit for the employees and the organization.

Any question or grouping of questions may be used as to identify the employees in Group One and Group Two, in addition, other metrics may be used such as performance levels of employees or any other demographic attribute. Once the employees with highest engagement combined with the favorable response to any item of interest, then this group can be used to find the largest difference in positive ratings about any other survey item.

The idea of Positive Divergence Analysis is to find an intuitively accessible way to understand the biggest difference in positive ratings between the engaged employees in an organization and the remainder of employees. By implementing changes in organizational procedures and policies it is possible for an organization to increase the ratings of the employees in Group Two so that they are more aligned or similar to the ratings of the employees in Group 1. The use of Positive Divergence Analysis results in a higher probability of achieving “Positive Organizational Alignment” and improved organizational functioning than other currently used methods.

Positive Divergence Analysis is an accurate, intuitive, and actionable method of analyzing and identifying areas of improvement in an organization, that if acted upon, will yield a significant increase in employee engagement and an increase in the probability of success of the company.

Table 1 below provides examples of the type of questions that could be utilized in the survey. Any number of other questions could be included and are others are used quite regularly in employee surveys.

TABLE I
The stress levels at work are manageable.
I am confident in my job security at this organization.
I am satisfied with my involvement in decisions that affect my work?
I have the opportunity to grow and develop at this organization.
We have a positive reputation as a good corporate citizen in our
community.
This organization's processes enable me to work quickly during customer
interactions.
At this organization, people are rewarded according to their job
performance.
Employees are encouraged to share their opinion on important issues.
organization.
I feel encouraged to come up with new and better ways of doing things.
I am paid fairly for the work that I do.

Case Studies

The following are descriptions of several organizations that have used Positive Divergence Analysis to the benefit of their employees as well the efficiency and profitability of their organization.

A. Global Tech Company

Company Description: This is a 7,000-person company growing rapidly through M&A in the technology industry, based in Silicon Valley.

Comparison: Positive Divergence Analysis was conducted using the responses of 5,128 employees, 197 of whom exited the organization within nine months of completing the survey. The comparison of the 197 who exited and the 4,931 who stayed, highlighted the role of employee/manager relationship in retaining employees. It was also observed that females at the Manager and Senior Manager level had the highest level of voluntary turnover. Additional Positive Divergence Analysis was run using gender at the Manager and Senior Manager level to identify key differences in experience and opinions by gender.

Insight: Females at the Manager and Senior Manager level were more critical of the employee/manager relationship and were dramatically less optimistic about their ability to advance with the company. Additional quantitative data was integrated and it showed that the average time in role was longer for females before they advanced when compared with their male colleagues.

Action: Broad communication around roles, objectives, and requirements to advance were shared with all employees at the target job level. Employee Resources Groups were deployed across the organization to foster community and connection among females at the Manager and Senior Manager Level.

Outcome: Engagement of females at the Manager and Senior Manager level had a statistically significant improvement. There was a 4% improvement in both Intent to Stay and Overall Engagement from Q1 to Q3. Improvements in Manager Relationship and Anticipation of Opportunities for Advancement also saw significant improvements within the target population. These were:
5% improvement in Clarity Around Department Goals,
6% improvement in Managers Treating Females (at the Manager/Sr. Manager Level) with respect, and
9% improvement in agreement that Feedback from Direct Manager helps the employee improve their performance.

Most importantly, there has been a decline in voluntary attrition from 5% turnover to 2% turnover from this group which is essential to the company's long-term goal of increasing gender diversity among their leadership positions.

B. US-Based Service Firm

Company Description: A 700 person company that services clients in retail industry.

Comparison: Positive Divergence Analysis was performed based on response to the four indicators of Engagement:
1. My work gives me a feeling of personal accomplishment,
2. I intend to stay with the company for at least the next twelve months,
3. I would recommend the company as a great place to work, and
4. I am proud to work for the company.

The Positive Divergence Analysis identified the independent variables within the work experience that had the greatest impact on employees:
1. Willingness to recommend the company as a great place to work,
2. Experience of intrinsic motivation, and
3. Intent to stay with the company for at least the next twelve months.

Insight: Recognition for good work and anticipation of career success through the support of associate development were the areas that had the greatest impact on Engagement.

Action: At the enterprise-level, human resources worked to clarify the career paths in the company, but the bigger changes took place at the employee-manager level. The company embraced the idea that it should be the responsibility of all managers to develop their employees. They implemented quarterly conversations where managers discussed performance, goals, and career aspirations on an ongoing basis.

Outcome: The second annual survey saw a favorable Maintenance of Intent to Stay from the original 81.7% to 83.9%, which was not statistically significant for a population of this size, which was already scored above external benchmarks, along with statistically significant improvements, from 62.4% favorable to 68.0%, in employees' willingness to recommend the company as a good place to work, along with four of the top five drivers of engagement.

The drivers were:
1. The organization strongly supports the development of its associates, +7.9% favorable,
2. My current responsibilities are positioning me for further success within the organization, +7.8% favorable,
3 Senior leaders give me confidence about the future of the organization, +9.2% favorable,
4. I am treated like a valued member of this organization, +6.7% favorable, and
5. I believe feedback from this survey will be used to make improvements. +0.6% (change not statistically significant).

C. Fortune 100 Healthcare Organization

Company Description: A 35,000+person manufacturing and distribution company competing in the healthcare/pharmaceutical industry with employees in over 30 countries

Comparison: Innovation was central to the company's strategic plan, so in this case we utilized an index of questions (Innovation Index) that are indicative of an innovative corporate culture, where employees are optimistic about the company's ability to drive continuous improvement efforts and managers demonstrate behaviors that foster innovation.

Insight: Positive Divergence Analysis, which compared those who responded favorably to all of the Innovation Index questions against the remainder of respondents highlighted, the importance and role of trust in both the employee/manager relationship and trust in leadership. Further analysis identified the specific manager actions that fostered trust where it was present, or eroded trust where it was not present in the data. The client learned that to unleash innovation within their business, they needed to foster trust, and there were a handful of specific actions that were critical to building and maintaining trust. The manager actions were demonstrating care for employee well-being, seeking employees' input when making important decisions, considering the opinions of others when making decisions, providing timely feedback, supporting career development, and addressing employee concerns quickly and appropriately.

Action: This information around trust, and specifically the behaviors associated with trust and innovation were incorporated into internal manager training courses. It also was incorporated as part of a company-wide campaign and was integrated into the company's internal management training curriculum.

Outcome: The changes in the manager training courses yielded higher survey scores (+6.8% favorable overall), in areas of trust and transparency (+7.9% favorable) but more importantly, it also correlated to higher employee engagement (+6.9% favorable) and company performance towards innovation-focused company-wide initiatives as communicated by the company's leadership, through an increased ability to innovate.

D. Global CPG Company

Company Description: A 10,000 person company with heritage brand

Comparison: Positive Divergence Analysis was conducted using data from an employee exit survey of 229 exited employees. Data from exited employees who responded to the exit survey and the company's prior employee census survey enabled an analysis of this group's perception and experience at the point when they left the company vs. their perceptions and experience months prior to turning in their notice to leave. Comparison of data from two points in time for the same group of employees is evidence that the persistence of issues cited as the primary reason someone left the organization.

Insight: Based on the exit survey data, dissatisfaction with the manager was the primary reason employees chose to leave the organization. In the exit survey, respondents had the option to select one of ten internal factors that most influenced their decision to leave the company. “Dissatisfaction with manager” was the most frequently selected option (19% of respondents). Positive Divergence Analysis was completed using this group of exited employees to identify the specific manager behaviors that yielded higher rates of voluntary turnover. Belief that managers did not keep commitments, and lack of feedback or recognition were the primary factors experienced by those who left due to dissatisfaction with the manager. When this group's responses on the prior all-employee survey were compared against the remainder of the company, again using Positive Divergence Analysis, we saw those experiments and opinions existed at least nine months before the person exited the company. This timeframe means it was not an isolated incident but rather an issue that existed months before action. It is possible that an intervention could have enabled the company to retain at least some of the exited employees.

Action: The insights from the analysis enabled the company to identify pockets of the organization with higher turnover due to a lack of manager support. Coaching was made available for those managers in an attempt to create a more positive atmosphere. Outcome: The work is ongoing, but if those efforts are not successful, action may be taken against some managers that fail to demonstrate the desired behavior change. The organization will continue to track turnover with the expectation that changes in manager behavior will yield a reduction in voluntary turnover over time.

E. US Home and Building Material Retailer

Company Description: A 5,000 employee retailer, growing almost 20% annually through expansion into new markets. The employee population skews younger with 28% of employees under the age of 25 and another 18% are 25-30.

Comparison: Positive Divergence Analysis was conducted using the indicators of Engagement. The engagement indicators already scored well above external benchmarks, so the challenge would be to maintain the high levels of engagement as the organization grows and matures.

Insight: It was observed that there were two key differentiators between those who are highly engaged and those who were not. The two differentiators were a) confidence the survey results would be used to make improvements and b) belief that sufficient effort is made by the company to get the opinions and thinking of the employees.

Action: Company-wide and store-level meetings took place to communicate the overall survey results, identified strengths and opportunities, and what management would do in the coming year to address the focus areas. We cautioned that employees often struggle to connect the dots between feedback that they provide on an employee survey and improvements that an organization makes throughout the year. Corporate messages frequently included reminders and touch points linking back to the survey results.

Outcome: Despite the significant organizational changes associated with rapid growth, the client successfully maintained their high levels of engagement. During times of significant change, it is common for organizations to experience declines in engagement before things begin to normalize and rebound. By focusing on the specific issues identified using Positive Divergence Analysis method of analysis, the company saw no decline in engagement and maintained their scores.

Although the invention has been described in detail, substitute equivalents may be made to the invention as described while still falling within the scope and spirit of the invention. Therefore the scope of the invention is not limited to the foregoing specification, but the scope is defined by the claims provided herein and their equivalents.

What is claimed is:

1. A method for enhancing a financial/business metric for an organization comprising the steps of:
a. generate a survey comprising a plurality of survey questions;
b. administer the survey to a plurality of employees of the organization;
c. identify a first subset of said survey questions such that a first subset of said employees answered said first subset of survey questions with positive responses;
d. identify a second subset of employees who each did not answer the first subset of survey questions with positive responses;
e. identify a second subset of survey questions in which the first subset of employees answered each question with positive results and which each question in the second subset of survey questions were answered by each employee in the second subset of employees with less positive responses.

2. A method for enhancing a financial/business metric for an organization comprising the steps of:
a. identify survey response data that has been previously administered to employees of an organization;
b. identify a first subset of said survey questions such that a first subset of said employees answered said first subset of survey questions with positive responses;
c. identify a second subset of employees who each did not answer the first subset of survey questions with positive responses;
d. identify a second subset of survey questions in which the first subset of employees answered each question with positive results and which each question in the second subset of survey questions were answered by each employee in the second subset of employees with less positive responses.

3. The method described in claim 1 wherein said first subset comprises a single survey question.

4. The method described in claim 1 wherein said first subset comprises a plurality of survey questions.

5. The method described in claim 2 wherein said first subset comprises a single survey question.

6. The method described in claim 2 wherein said first subset comprises a plurality of survey questions.

7. The method described in claim 1 wherein said plurality of survey questions deal with engagement.

8. The method described in claim 2 wherein said plurality of survey questions deal with engagement.

9. The method of claim 1 further comprising a paragraph f to be performed after paragraph e, providing to the organization, possible changes in the operation of the organization wherein said changes are designed to improve the responses of the second set of employees to the conditions described in the second subset of survey questions.

10. The method of claim 2 further comprising a paragraph e to be performed after paragraph d, providing to the organization, possible changes in the operation of the organization wherein said changes are designed to improve the responses of the second set of employees to the conditions described in the second subset of survey questions.

11. The method of claim 1 wherein said method is performed with the aid of a computer.

12. The method of claim 2 wherein said method is performed with the aid of a computer.
